(19) United States
(12) Patent Application Publication
(10) Pub. No.: US 2010/0155246 A1
(43) Pub. Date: Jun. 24, 2010

(54) ELECTRIC FIELD CAGE AND ASSOCIATED OPERATING METHOD

(75) Inventors: Thomas Schnelle, Berlin (DE); Torsten Müller, Berlin (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: PERKINELMER CELLULAR TECHNOLOGIES GERMANY GMBH, Hamburg (DE)

(21) Appl. No.: 12/161,062

(22) PCT Filed: Jan. 17, 2007
(86) PCT No.: PCT/EP2007/000390

§ 371 Date: Aug. 29, 2008

(30) Foreign Application Priority Data
Jan. 18, 2006 (DE) 10 2006 002 462.1

(51) Int. Cl. B01D 57/02

(52) U.S. Cl. 204/547; 204/643

(57) ABSTRACT

The invention relates to an electric field cage (6) for spatially fixing particles (2, 3) which are suspended in a carrier liquid, in particular in a microfluidic system, including a plurality of cage electrodes (7, 8), which can be electrically driven, for generating a capture field. It is proposed that at least one of the cage electrodes (8) is annular and surrounds the other cage electrode (7). The invention also covers an associated operating method.

The invention relates to an electric field cage and to an associated operating method, according to the preamble of the independent claims.

Müller, T. et al.: “A 3D-Microelectrode for Handling and Caging Single Cells and Particles”, Biosensors and Bioelectronics 14, 247-256, 1999 discloses microfluidic systems with dielectrophoretic field cages which allow spatial fixing of the suspended particles in the flowing carrier fluid, and therefore according to their function these electrode arrangements are also referred to as field cage. The known field cages have a three-dimensional electrode configuration with, for example, eight cage electrodes arranged in a cube shape.

One disadvantage of these known three-dimensional field cages is, besides the necessary precise assembly of the three-dimensional electrode arrangement, also the unsatisfactory ratio between fixing force, the required electrical voltage for actuating the field cages and the thermal heating of the fixed particles as a result of the electrical actuation of the field cage. For instance, the particles in this case are trapped centrally between the electrode planes, where on the one hand the trapping forces are at their lowest and on the other hand the flow rate in the channel and thus the deflecting forces are at their greatest. Although an increase in voltage during actuation of the conventional field cages leads to a desired increase in the fixing force, this is nevertheless associated with an undesirable increase in heating of the fixed particles, particularly in physiological or more highly conductive media.

Also known, from FUHR, G. et al.: “Levitation, holding, and rotation of cells within traps made by high-frequency fields”, Biochimica et Biophysica Acta, 1108 (1992) 215-223, are planar field cages in which the cage electrodes are arranged in a common electrode plane.

One disadvantage of these planar electrode arrangements is the fact that the particles to be fixed are repelled at right angles to the electrode plane in the case of negative dielectrophoresis, so that these electrode arrangements alone are not suitable for fixing and holding particles. However, the known planar electrode arrangements can be used as field cages if an additional force is utilized, such as for example the force of gravity or the force generated by laser tweezers.

The object of the invention is therefore to provide a correspondingly improved field cage.

This object is achieved by a field cage and an associated operating method according to the independent claims.

The invention encompasses the general technical teaching that at least one of the cage electrodes annularly surrounds the other cage electrode.

The term “annular cage electrode” used in the context of the invention is not limited from the geometric point of view to circular cage electrodes, but rather encompasses various shapes. By way of example, the annular cage electrodes may be polygonal, rectangular, elliptical or generally round.

In one preferred embodiment, the outer annular electrode surrounds an inner annular electrode. In another preferred embodiment, these two annular electrodes surround a third electrode, which is circular for example. Both arrangements are particularly suitable for the manipulation of particles by means of negative dielectrophoresis.

The term “annular electrode” used in the context of the invention encompasses on the one hand annular electrodes in the narrower sense, which are not filled in on the inside. On the other hand, however, this term also encompasses electrodes in which only the perimeter is annular, while the electrodes are filled in on the inside.

Furthermore, the invention encompasses the general technical teaching of using, instead of the known three-dimensional field cages described in the introduction, a substantially planar electrode structure as the field cage.

The term “planar field cage” used in the context of the invention is preferably to be understood to mean that the individual cage electrodes are arranged on just one side with respect to the particle to be fixed, whereas the particles to be fixed in the case of the conventional three-dimensional field cages described in the introduction are fixed inside the field cage, so that the individual cage electrodes surround the fixed particles on different sides.

The cage electrodes are therefore preferably located on a substrate (i.e. a surface), which may be for example glass, plastic or silicon. The substrate comprising the cage electrodes may be arranged for example on an upper channel wall of the carrier flow channel or on a lower channel wall of the carrier flow channel.

Preferably, the individual cage electrodes have a vertical electrode spacing which is smaller than the lateral electrode spacing, whereas the electrode spacing in the case of the conventional three-dimensional field cages described in the introduction is much larger.

In one preferred example of embodiment, the field cage according to the invention has precisely two cage electrodes, but in terms of the number of cage electrodes the invention is not limited to precisely two cage electrodes for spatially fixing the suspended particles. Instead, it is also possible for example that the field cage according to the invention has three, four, six or eight cage electrodes or another number of cage electrodes.

Furthermore, the individual cage electrodes of the field cage are preferably in each case planar and preferably aligned parallel with one another.

In one variant of the invention, all the cage electrodes are arranged in a common electrode plane, so that the entire electrode arrangement is exactly planar.

By contrast, in another variant of the invention, the cage electrodes are arranged in two parallel planes which are offset with respect to one another. However, this variant may also be referred to as a planar electrode arrangement in the context of the invention, since the individual cage electrodes are arranged on just one side with respect to the particle to be fixed.

Furthermore, the vertical electrode spacing here is preferably also much smaller than the lateral dimension of the electrodes. In this case, the inner annular cage electrodes may optionally be arranged above or below the outer annular cage electrode.

In the context of the invention, the annular cage electrodes may be arranged concentrically or eccentrically with respect to one another, but preference is given to a concentric arrangement of the cage electrodes.

In one preferred example of embodiment of the invention comprising two annular cage electrodes, the inner annular cage electrode surrounds an opening in a channel wall of a carrier flow channel, it being possible for the suspended particles to enter or exit through the opening in the channel wall. Through the opening in the channel wall of the carrier flow channel, the suspended particles can be transferred for example into fluidic rest zones (e.g. storage reservoirs) or into other channels.

It is also possible in the context of the invention that at least one of the annular cage electrodes is open at one side and/or has a passivation layer at one side, in order to weaken the electrode arrangement in a certain direction. The use of passivation layers to weaken the field cage has the advantage here that the relative weakening of the field barrier produced by the field cage can be controlled via the frequency of the field. In this case, molecules used in cell biology, such as lamin for example, may serve as insulation layer. This makes use of the fact that the coupling of the field into the carrier solution above the provided passivation layer is dependent on the frequency and the medium. For instance, the coupling of the field into the carrier solution increases with the frequency and decreases with the ratio of the conductivities of the medium and passivation layer and the thickness of the passivation layer.

By applying a lower frequency, the field cage opens in the directions of the passivation layers. The field cage can do this simultaneously if all the passivations are the same. However, it is also possible that different passivation layers are applied and the field cage is then opened for example successively/selectively at these points.

As an alternative, the flowing-in of a different medium (e.g. having a different conductivity) can be used as a switch. This method may facilitate both the filling of the nDEP ring array (which can be simplified by deflectors and/or funnels placed upstream) and the release in defined directions. In addition, preference can thus also be given in a targeted manner to certain cell growth directions. This may be used for example to build a defined neuronal network. To this end, an array of nDEP ring structures on for example a rectangular grid is filled firstly with individual neurons. The growth of the axons can be permitted/switched according to the predefined passivations. This may also take place individually in the case of nDEP ring structures which can be controlled individually. As an alternative, the openings may also be formed by a laser by the ablation of electrode material after the growing of the cells. nDEP ring arrays can moreover be used for the collection and optionally subsequent cryopreservation of especially particulate material from suspensions.

It is also possible in the context of the invention that the individual cage electrodes are optionally of the same or different shape.

Furthermore, the field cage according to the invention has a certain trapping point (minimum of the electric field in the case of negative dielectrophoresis) at which the particles are spatially fixed, the trapping point optionally being located directly on a channel wall of the carrier flow channel or being at a distance from the channel walls of the carrier flow channel. Fixing the suspended particles close to the wall offers the advantage that the flow velocity at that point is much lower than in the centre of the carrier flow channel, so that lower retaining forces are sufficient for spatially fixing the suspended particles.

Furthermore, it is possible in the context of the invention that the substrate is provided with a passivation layer, a biochemical coating and/or a nanolayer. The biochemical coating of the substrate may for example modify the adhesion properties of the substrate for the particles to be fixed and/or set differentiation signals for the particles to be fixed.

In one variant, different coatings are applied to the substrate inside the inner annular cage electrode and outside the inner annular cage electrode, the coating inside the inner annular cage electrode having an adhesive (attracting) effect on the particles to be fixed, while the coating outside the inner annular cage electrode has a repulsive (repelling) effect on the particles to be fixed.

In a further variant of the invention, the substrate comprising the cage electrodes of the field cage is not arranged on a channel wall of the carrier flow channel, but rather the substrate extends through the carrier flow channel centrally in the flow direction in the form of a membrane, so that the substrate divides the carrier flow channel into two sub-channels. This is particularly advantageous when the substrate contains an opening through which particles can pass from one sub-channel to the other sub-channel of the carrier flow channel.

The field cage according to the invention is preferably a dielectrophoretic field cage, wherein optionally positive dielectrophoresis or negative dielectrophoresis can be used in order to spatially fix the suspended particles.

Furthermore, the invention encompasses a variant comprising a plurality of field cages with in each case preferably two or three cage electrodes, each of the individual field cages allowing a spatial fixing of one or more suspended particles. The individual field cages are in this case arranged in matrix form in a plurality of columns and a plurality of rows, wherein the electrical actuation of the field cages takes place by means of a plurality of column control lines and a plurality of row control lines. For each column of field cages, in each case a common column control line is provided for all field cages of the respective column, the column control line being connected in each case to the first cage electrode of each electrode arrangement of the respective column. In the same way, for each row of field cages, in each case a common row control line is provided for all field cages of the respective row, the row control line being connected in each case to the second cage electrode of each electrode arrangement of the respective row. In the variant with three cage electrodes, one of the cage electrodes can optionally be electrically controlled separately or be at a floating electric potential.

It should also be mentioned that the invention encompasses not only the field cage described above but also a microfluidic system comprising such a field cage and also a cell biology equipment item comprising such a microfluidic system, such as for example a cell sorter, a cell screening device or the like.

Furthermore, the invention also encompasses the use of a microfluidic system according to the invention in such a cell biology equipment item.

Moreover, the invention also encompasses a micromanipulator for manipulating suspended particles, wherein the micromanipulator according to the invention comprises a field cage according to the invention for fixing the suspended particles. By way of example, the micromanipulator may be designed as dielectrophoretic tweezers.

Besides metals and doped semiconductors, conductive polymers, such as for example polyaniline, polypyrrole or polythiophene are also possible as the electrode material. The use of laser-modifiable polymers is also advantageous, such as polybisalkylthioacetylene. In the direct laser inscription method, electrodes can in this way be written to a polymer chip, which is particularly advantageous for building prototypes.

Finally, the invention also relates to a corresponding operating method for the above-described microfluidic system according to the invention.

Here, it is possible that the field cage is actuated at different frequencies for spatially fixing the particles and for subsequently releasing the fixed particles. For instance, actuation for spatially fixing the suspended particles preferably takes place at a frequency which is high enough to form a trapping field. By contrast, the subsequent electrical actuation for releasing the fixed particles takes place at a lower frequency which is sufficiently low to open the trapping field at least in the region of the opening or the passivation layer.

The opening, already described above, of the annular cage electrodes at one side may in the context of the operating method according to the invention for example be achieved in that the cage electrodes are irradiated by a laser, so that electrode material is removed from the irradiated cage electrodes, as a result of which the desired opening is formed.

Furthermore, in the operating method according to the invention, it can also be checked preferably by optical methods whether particles are fixed in the individual field cages or not. Such an occupancy check is particularly advantageous when the microfluidic system comprises numerous electrode arrangements for fixing particles. In this case, the microfluidic system is firstly loaded with particles until all the field cages are occupied by suspended particles. The loading phase can then be terminated and can be followed by further operating phases. The occupancy check therefore makes it possible to minimize the time required for the loading phase while simultaneously ensuring full occupancy of all the electrode cages.

Furthermore, in the case of a plurality of field cages, a chemical gradient can be generated between the individual field cages by influencing the flow accordingly. By way of example, chemical additives may be introduced into the microfluidic system along with the carrier flow, it being possible for the inflow of the additives to be varied temporally and/or spatially within the carrier flow.

The electrode arrangement which serves for particle fixing may additionally be used for a further purpose. For example, the electrode arrangement may be electrically controlled in order to trigger a stimulation of the particles fixed therein and/or to carry out an electrical measurement (e.g. impedance).

Finally, it should also be mentioned that the suspended particles are preferably biological cells. However, with regard to the particles to be fixed, the invention is not limited to biological cells but rather also allows the fixing of cell aggregates or other particles.

Other advantageous further developments of the invention are characterized in the dependent claims or will be explained in more detail below together with the description of the preferred examples of embodiments of the invention with reference to the figures, in which:

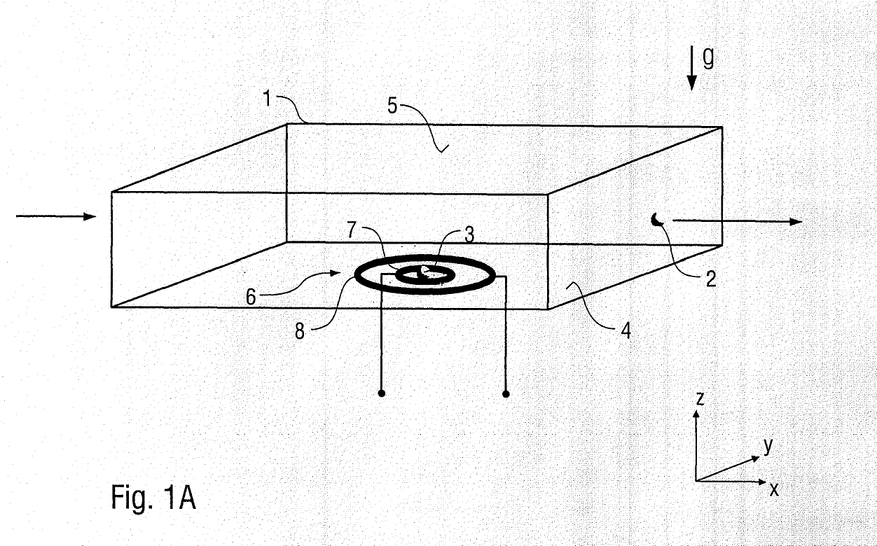

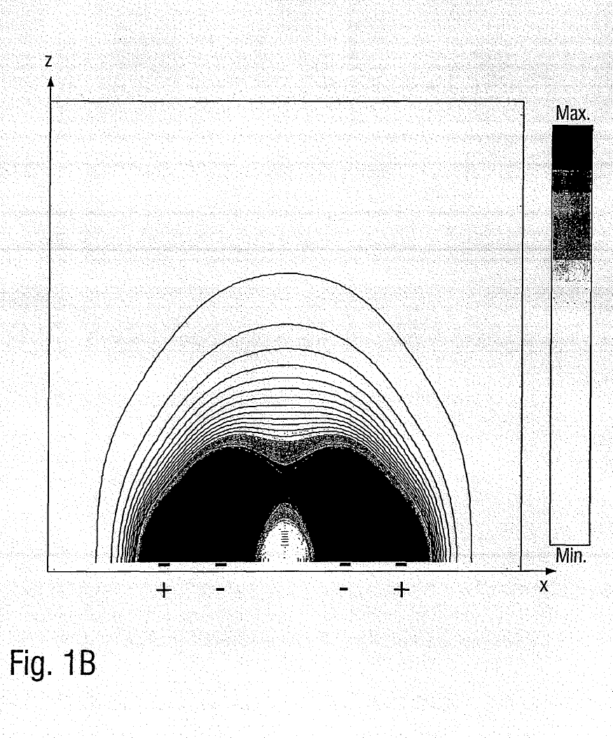

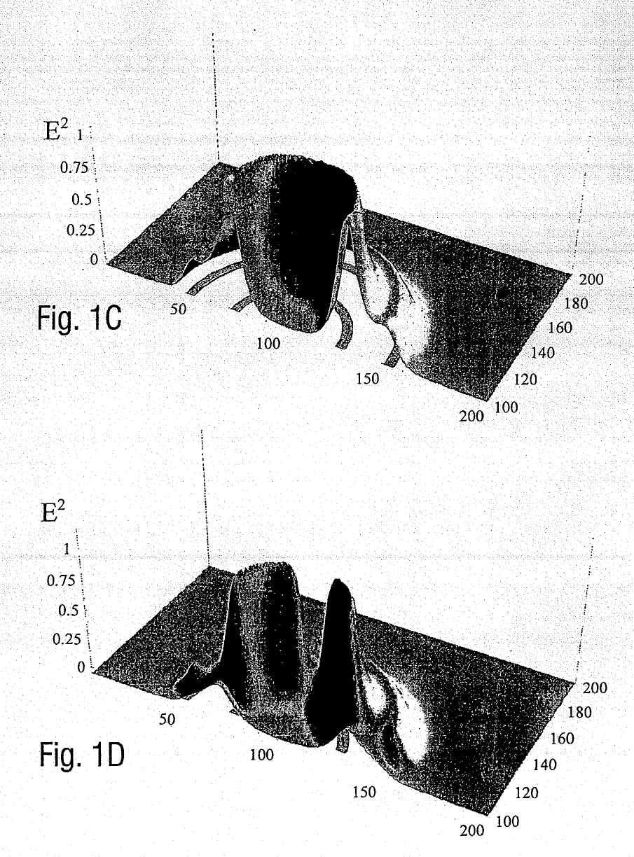

FIG. 1A shows a preferred example of embodiment of a microfluidic system according to the invention comprising one field cage with two concentric annular cage electrodes, which are attached to the lower wall of the carrier flow channel and allow a spatial fixing of the suspended particles,

FIGS. 1B, 1C show the field distribution for the field cage of FIG. 1A,

FIG. 1D shows the field distribution for a double-annular field cage, in which the annular electrodes are opened in the form of a cross,

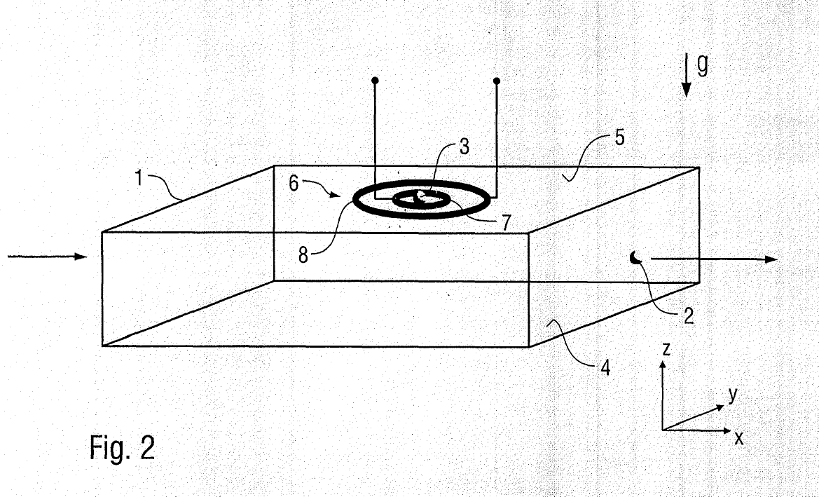

FIG. 2 shows an alternative example of embodiment in which the field cage is arranged on the upper channel wall of the carrier flow channel,

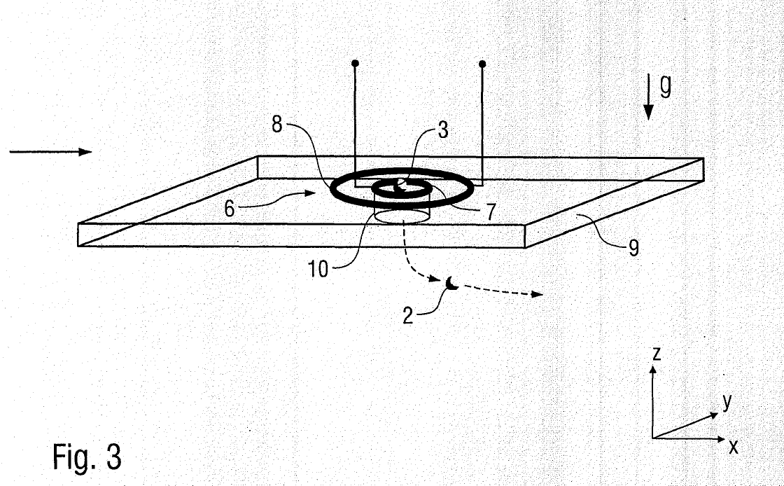

FIG. 3 shows a substrate which carries a field cage, wherein the substrate may be arranged for example in the channel centre in the carrier flow channel and allows the through-passage of the suspended particles,

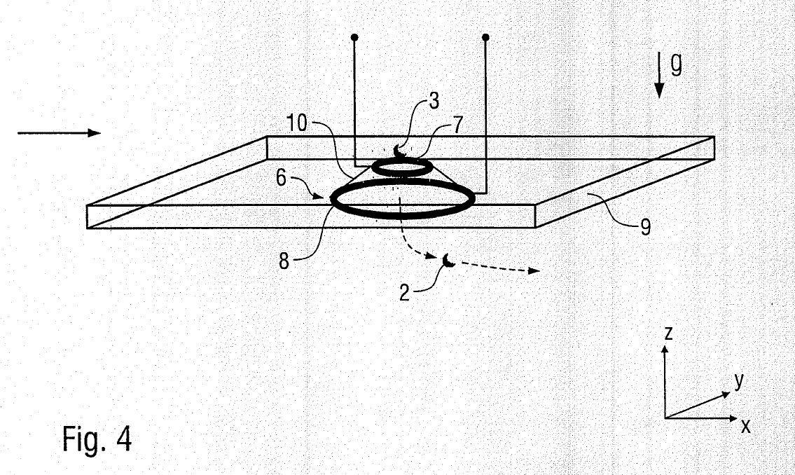

FIG. 4 shows an alternative example of embodiment of such a substrate with a different configuration of the field cage,

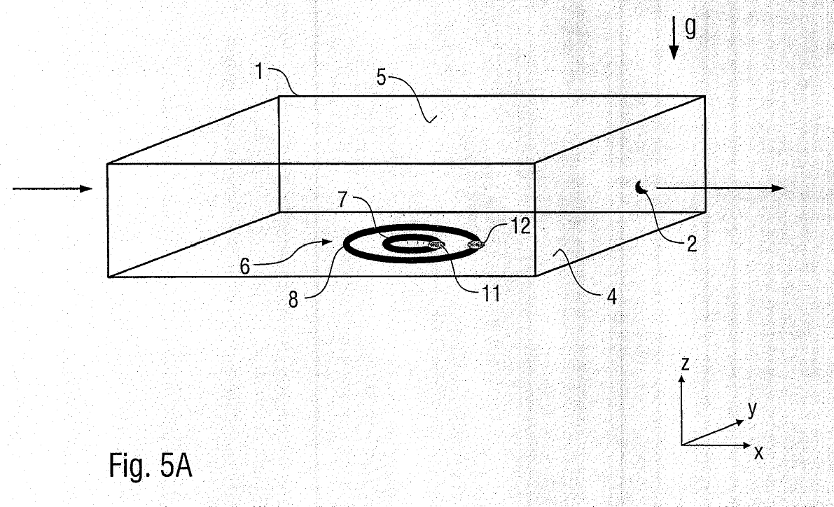

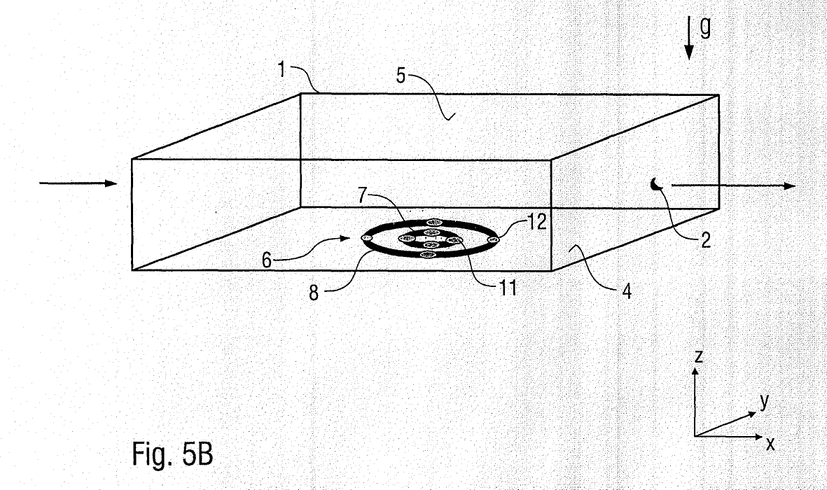

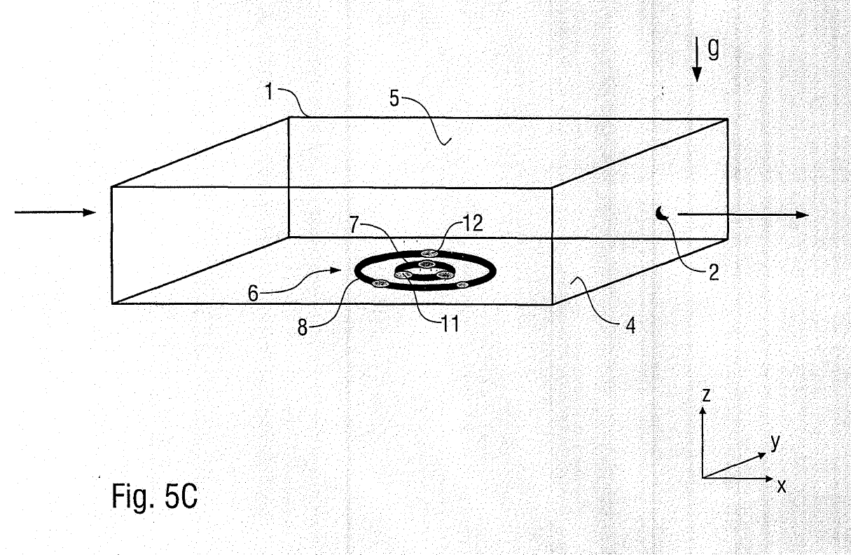

FIG. 5A shows an alternative example of embodiment of a microfluidic system according to the invention with a field cage, wherein the field cage consists of two annular concentric cage electrodes on the lower channel wall which have passivation layers at one side,

FIG. 5B shows a modification of the example of embodiment according to FIG. 5A, wherein the passivation layers produce a weakening in four directions,

FIG. 5C shows a modification of the example of embodiment according to FIG. 5A, wherein the passivation layers produce a weakening in three directions,

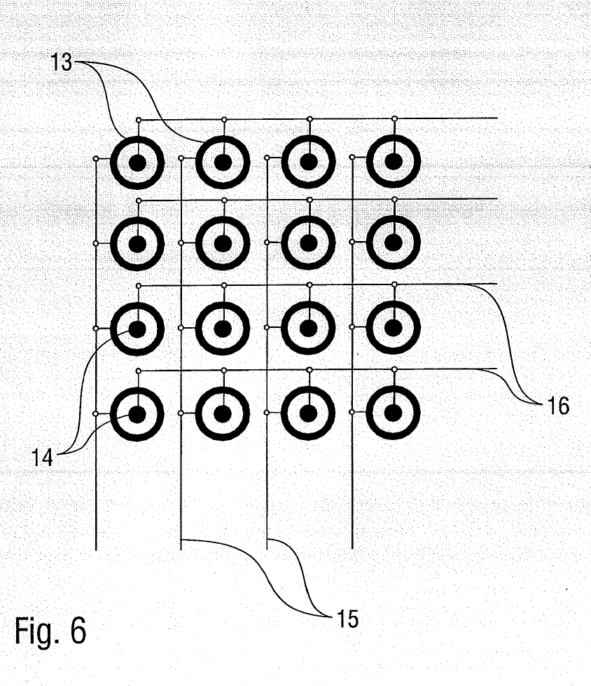

FIG. 6 shows an alternative example of embodiment comprising a matrix-type arrangement of a plurality of field cages for particle fixing,

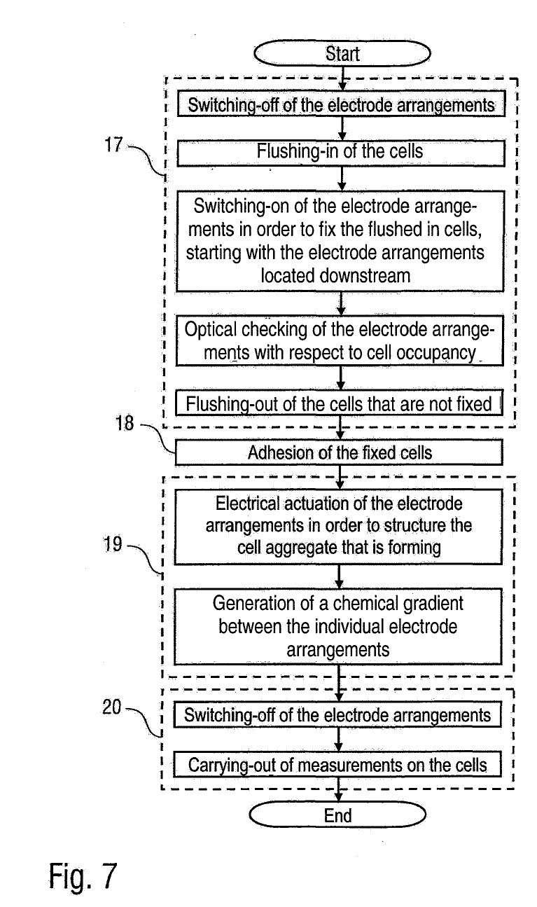

FIG. 7 shows the operating method according to the invention in the form of a flow chart,

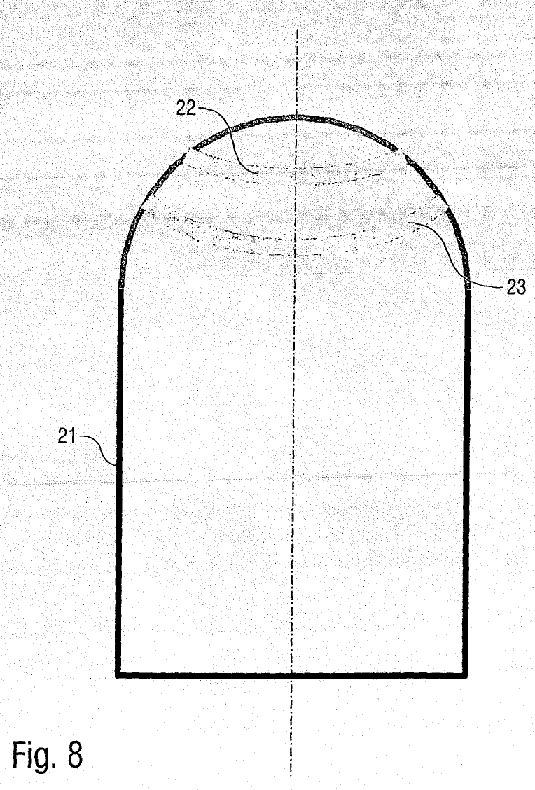

FIG. 8 shows dielectrophoretic tweezers according to the invention,

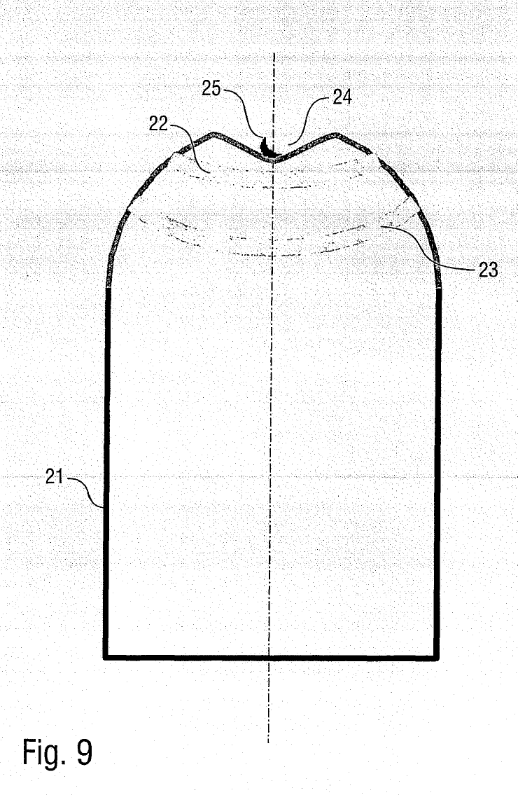

FIG. 9 shows a further example of embodiment of dielectrophoretic tweezers according to the invention,

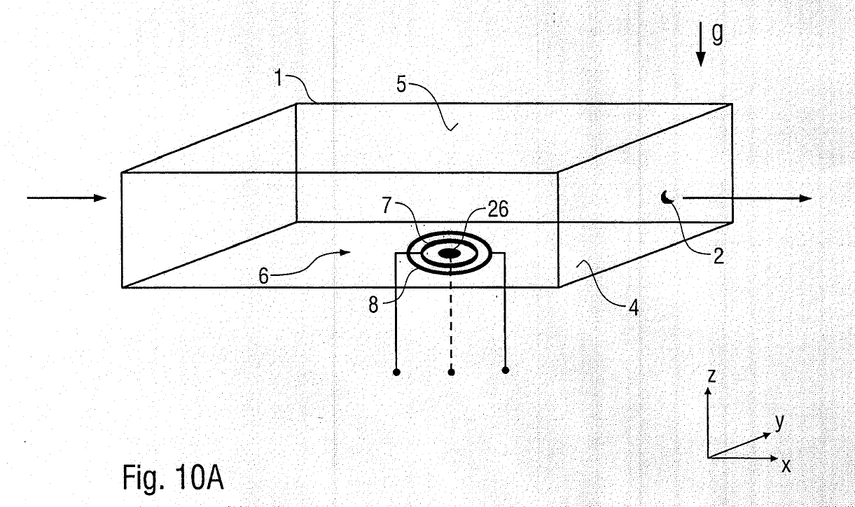

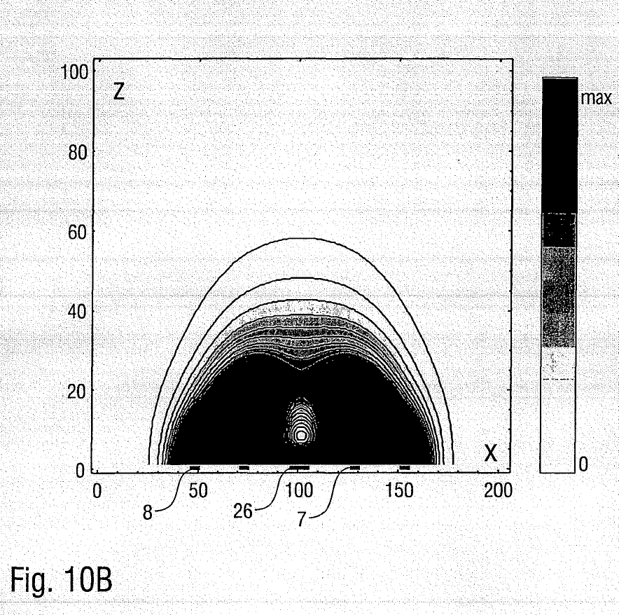

FIG. 10A shows a further example of embodiment of a microfluidic system according to the invention comprising a field cage with three concentric annular cage electrodes,

FIG. 10B shows the field distribution for the field cage according to FIG. 10A,

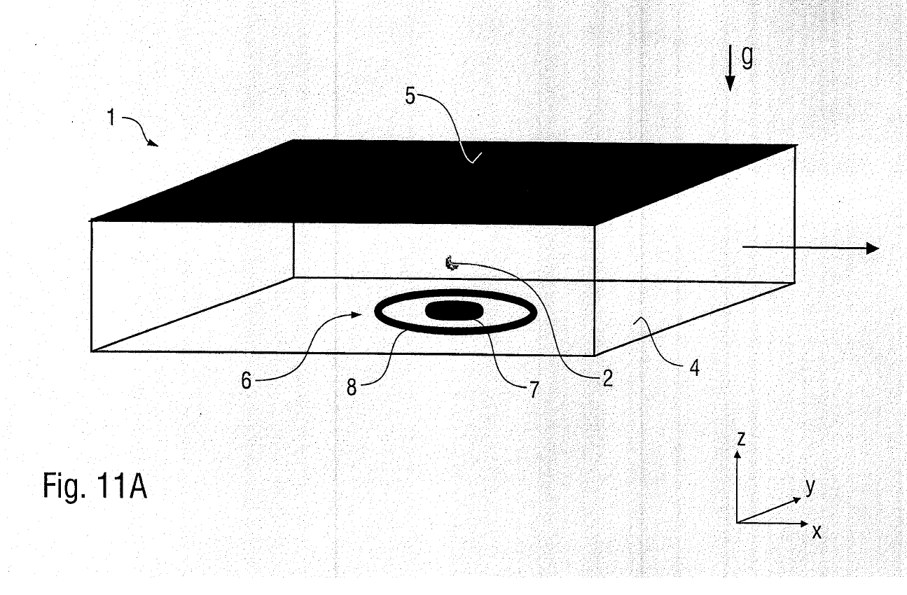

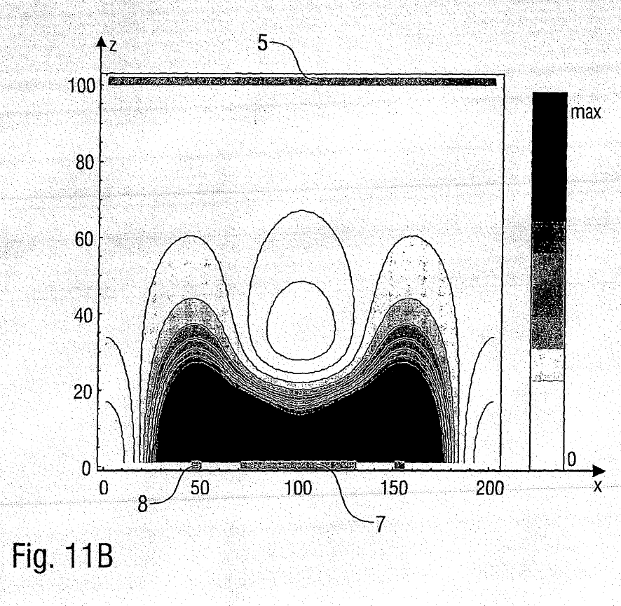

FIG. 11A shows a further example of embodiment of a microfluidic system comprising a flat counter-electrode,

FIG. 11B shows the field distribution for the microfluidic system according to FIG. 11A, and

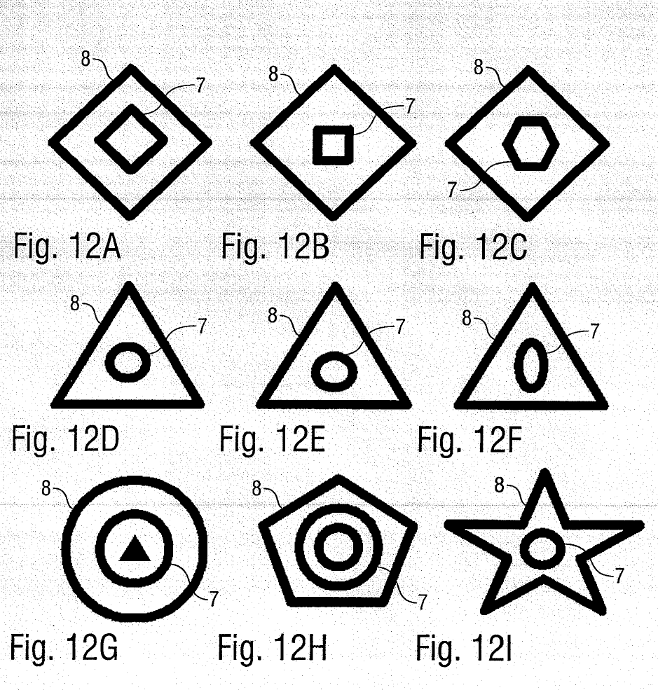

FIGS. 12A-12I show various examples of embodiments of field cages according to the invention.

FIG. 1A shows in simplified form an example of embodiment of a microfluidic system according to the invention with one carrier flow channel 1, through which a carrier fluid with particles 2, 3 suspended therein flows in the X direction.

Here, the carrier flow channel 1 has a lower channel wall 4 and an upper channel wall 5, with a field cage 6 being arranged on the lower channel wall 4, said field cage consisting of two circular, concentric annular electrodes 7, 8 which can be controlled independently of one another and allow a spatial fixing of the particle 3 in the flowing carrier fluid, due to the field cage 6 generating an electric trapping field which is shown in a perspective view in FIGS. 1B and 1C.

The two annular electrodes 7, 8 are in this case arranged in a coplanar manner in a common electrode plane, so that the trapping point likewise lies in the common electrode plane directly on the lower channel wall 4. This fixing of the particle 3 close to the wall is advantageous since the flow velocity at that point is lower than in the centre of the carrier flow channel 1, so that relatively small retaining forces are sufficient to spatially fix the particle 3. This in turn allows a relatively weak electrical actuation of the field cage 6, so that the fixed particle 3 is only slightly impaired by field effects. Moreover, the particle 3 can be fixed to the bottom by additional forces (e.g. forces of inertia and the force of gravity g) in an assisting manner.

FIGS. 1B and 1C show the field profile for the field cage 6 according to FIG. 1A in a central vertical section through (FIG. 1B) and in a horizontal plane above the electrode structure (FIG. 1C).

Furthermore, FIG. 1D shows the field profile in a horizontal plane above the electrode structure for a modified field cage in which the annular cage electrodes 7, 8 are not closed but rather are opened in the shape of a cross.

The alternative example of embodiment shown in FIG. 2 largely corresponds to the example of embodiment described above and shown in FIG. 1 so that, in order to avoid repetitions, reference is made to the above description relating to FIG. 1, with the same references being used for corresponding components.

One special feature of this example of embodiment lies in the fact that the field cage 6 is arranged not on the lower channel wall 4 but rather on the upper channel wall 5 of the carrier flow channel 1. By superposing with additional forces, e.g. forces of inertia or the force of gravity g, the trapping point can also be displaced from the channel wall into the solution.

FIG. 3 shows a simplified perspective view of a substrate 9 made from glass, plastic or silicon, with the field cage 6 as already described above with reference to FIGS. 1 and 2. In order to avoid repetitions, therefore, with regard to the field cage 6 reference is made to the above description relating to FIG. 1.

Here, the substrate 9 contains a cylindrical opening 10, through which the particles 2, 3 can pass from one side of the substrate 9 to the other side of the substrate 9, as illustrated schematically by the dashed arrow lines. The substrate 9 therefore acts as a partition wall and may, for example in the case of the microfluidic system shown in FIG. 1, be arranged as a membrane in the centre of the carrier flow channel 1 and extend in the longitudinal direction of the carrier flow channel 1, so that the substrate 9 in the carrier flow channel 1 separates two adjacent sub-channels from one another.

FIG. 4 shows an alternative example of embodiment of a substrate 9 which largely corresponds to the example of embodiment described above and shown in FIG. 3 so that, in order to avoid repetitions, reference is made to the above description relating to FIG. 3, with the same references being used below for corresponding parts.

One special feature here lies in the fact that the opening 10 in the substrate 9 tapers conically upwards, with the two annular electrodes 7, 8 being arranged in different electrode planes. The two electrode planes are in this case aligned parallel with one another and are arranged at a distance from one another, as a result of which the trapping point is lifted out of the electrode plane. However, the field cage 6 here can likewise be referred to as a planar electrode arrangement, since the individual cage electrodes are arranged on just one side with respect to the particle to be fixed. Preferably here too, the distance between the electrode planes may be smaller than the lateral electrode dimension, i.e. the electrode dimension in the Y direction.

FIG. 5A shows another example of embodiment of a microfluidic system according to the invention which largely corresponds to the example of embodiment described above and shown in FIG. 1 so that, in order to avoid repetitions, reference is made to the above description relating to FIG. 1, with the same references being used for corresponding parts.

One special feature of this example of embodiment lies in the fact that the two annular electrodes 7, 8 in each case have a passivation layer 11 and 12 respectively on the downstream side. The passivation layers 11, 12 weaken the trapping field generated by the field cage 6 in the region of the passivation layer 11 and 12, respectively.

It should be mentioned here that a weakening in the respective direction can also be achieved by applying a passivation only to the inner ring or only to the outer ring. Applications for the examples of embodiments according to FIGS. 5B and 5C are for example neuronal networks or rectangular or triangular lattices.

It is possible here to arrange a further electrode inside the inner annular electrode 7, which further electrode may have a passivation layer.

FIG. 5B shows a corresponding example of embodiment with four points of weakening, while FIG. 5C shows a further example of embodiment with three points of weakening.

Furthermore, FIG. 6 shows an alternative example of embodiment of a microfluidic system comprising numerous field cages arranged in matrix form, each of said field cages consisting of two concentrically arranged annular electrodes 13, 14.

The individual field cages are in this case arranged in matrix form in four rows and four columns and are electrically controlled by four column control lines 15 and four row control lines 16. Here, the individual column control lines 15 are in each case connected to the outer annular electrode 13 of all field cages of the respective column. In the same way, the individual row control lines 16 are in each case connected to the inner annular electrode 14. If, for example, all row control lines are controlled with signals of one phase and all column control lines are actuated with signals of an opposite phase, particles can be fixed in all field cages. An individual particle can then be released by grounding the corresponding row control line and column control line.

The flow chart in FIG. 7 shows the operating method for a microfluidic system comprising the matrix-type electrode arrangement shown in FIG. 6.

The operating method here consists essentially of a loading phase 17, a consolidation phase 18, a growth/differentiation phase 19 and an analysis phase 20, which will be described in more detail below.

In the loading phase 17, firstly all the field cages arranged in matrix form are switched off and biological cells are flushed in. Subsequently, in order to fix the introduced cells, the field cages are then switched on and dielectrophoretically actuated, starting with the downstream field cages. As a result, biological cells are in each case spatially fixed in the individual field cages. During this, an optical occupancy check of the individual field cages is carried out, and the non-fixed cells are flushed out as soon as all the field cages are occupied by biological cells.

In the subsequent consolidation phase 18, the fixed cells then adhere. The electric field may be reduced or even completely switched off, depending on the degree of adhesion and the flow conditions.

In the subsequent growth/differentiation phase 19, the field cages which serve for spatially fixing the cells are then electrically actuated in a particular way in order to structure the cell aggregate that is forming.

Furthermore, during the growth/differentiation phase 19, a chemical gradient may be generated between the individual field cages by influencing the flow conditions accordingly.

Finally, in the analysis phase, an analysis of the cell aggregates that have formed is carried out. For this purpose, the cage electrodes are switched off and the desired measurements are carried out, with optical or electronic measurements being possible for example.

This operating method can also be used to build a defined neuronal network.

FIG. 8 shows a simplified diagram of dielectrophoretic tweezers 21 which can be used to remove suspended particles from a carrier fluid.

At their distal end, the tweezers 21 have a semispherical tip which carries two annular cage electrodes 22, 23 which can be electrically controlled independently of one another and allow a fixing of the suspended particles, so that the fixed particles can be manipulated in the carrier fluid or removed therefrom together with the tweezers 21.

FIG. 9 shows an alternative example of embodiment of tweezers 21 according to the invention which largely corresponds to the example of embodiment described above so that, in order to avoid repetitions, reference is made to the above description, with the same references being used for corresponding components.

One special feature of this example of embodiment lies in the fact that the tweezers 21 have at their distal end a depression 24 in which a particle 25 can be fixed.

The alternative example of embodiment of a microfluidic system shown in FIG. 10A largely corresponds to the example of embodiment described above and shown in FIG. 1 so that, in order to avoid repetitions, reference is made to the above description relating to FIG. 1, with the same references being used for corresponding components.

One special feature of this example of embodiment lies in the fact that the field cage 6 has three cage electrodes 7, 8, 26, it being possible for the outer cage electrodes 7, 8 to be electrically controlled independently of one another, as has already been described above.

By contrast, the inner cage electrode 26 may optionally be at a floating electric potential or may likewise be electrically actuated, as indicated by the control line shown in dashed line.

Finally, FIG. 10B shows the field distribution of the field cage 6 according to FIG. 10A in a central vertical section through the electrode structure, wherein the electrodes 7 and 8 are actuated with opposite phase and the electrode 26 is grounded.

FIG. 11A shows a simplified perspective view of a further example of embodiment of a microfluidic system according to the invention which largely corresponds to the microfluidic systems described above so that, in order to avoid repetitions, reference is made to the above description, with the same references being used for corresponding details below.

One special feature of this example of embodiment lies in the fact that the upper channel wall 5 of the carrier flow channel 1 is in this case designed as a flat counter-electrode. The counter-electrode here is made from a transparent material in order to allow an undisrupted optical observation through the upper channel wall 5. By way of example, the flat counter-electrode on the upper channel wall 5 may consist of indium tin oxide (ITO); however, other materials are also possible.

By contrast, the field cage 6 in this example of embodiment is arranged on the lower channel wall 4 and therefore is located opposite the flat counter-electrode on the upper channel wall 5.

With this arrangement, it is possible even with simple circular annular structures to realize nDEP field cages which are able to hold the particles 2 in free solution, which is of particular interest with regard to arrays.

FIG. 11B shows the field distribution E² in the microfluidic system according to FIG. 11A in the z-y plane, which centrally sections the field cage 6.

The central annular electrode 7 here has the same electric potential as the counter-electrode on the upper channel wall 5, while the outer annular electrode 8 is at the opposite electric potential, which is achieved by a phase shift of 180°.

As an alternative, the inner annular electrode 7 and the counter-electrode 5 are grounded or are at a free potential, while the annular electrode 8 is actuated with an alternating field.

FIGS. 12A-12I show alternative examples of embodiments of field cages according to the invention.

In the example of embodiment shown in FIG. 12A, the two annular electrodes 7, 8 are each of square shape and are arranged with their edges parallel to one another.

In the example of embodiment shown in FIG. 12B, the two annular electrodes 7, 8 are again in each case of square shape, but the annular electrode 7 is rotated through an angle of 45° with respect to the annular electrode 8.

In the example of embodiment shown in FIG. 12C, the annular electrode 8 is of square shape, while the annular electrode 7 is of hexagonal shape.

In the examples of embodiments shown in FIG. 12D to FIG. 12F, the outer annular electrode 8 has the shape of an equilateral triangle. The inner annular electrode 7 in these examples of embodiments is circular or elliptical, with FIGS. 12D and 12E differing by a centric (FIG. 12D) or eccentric (FIG. 12E) arrangement of the inner annular electrode 7 inside the outer annular electrode 8.

In the field cage shown in FIG. 12G, the two annular electrodes 7, 8 are in each case circular and concentric, with a triangular further electrode being arranged centrally inside the inner annular electrode 7.

In the example of embodiment shown in FIG. 12H, the outer annular electrode 8 has the shape of a pentagon, while the inner annular electrode 7 is circular and is arranged centrally inside the outer annular electrode 8. Furthermore, in this example of embodiment, a further annular electrode is arranged inside the inner annular electrode 7.

In the example of embodiment shown in FIG. 12I, the outer annular electrode 8 is star-shaped, while the inner annular electrode 7 is circular and is arranged centrally inside the outer annular electrode 8.

The invention is not limited to the preferred examples of embodiments described above. Instead, a plurality of variants and modifications are possible which likewise make use of the inventive concept and therefore fall within the scope of protection.

### LIST OF REFERENCES

1 carrier flow channel

2 particle

3 particle

4 lower channel wall

5 upper channel wall

6 field cage

7 annular electrode

8 annular electrode

9 substrate

10 opening

11 passivation layer

12 passivation layer

13 annular electrodes

14 annular electrodes

15 column control line

16 row control line

17 loading phase

18 consolidation phase

19 growth/differentiation phase

20 analysis phase

21 tweezers

22 cage electrode

23 cage electrode

24 depression

25 particle

26 cage electrode

1. An electric field cage for spatially fixing particles which are suspended in a carrier fluid, said electric field cage comprising a plurality of electrically controllable cage electrodes for generating a trapping field, wherein at least one of the cage electrodes is annular and surrounds another cage electrode.

2. The field cage according to claim 1, wherein precisely two cage electrodes are provided.

3. The field cage according to claim 1, wherein a lateral electrode dimension of the cage electrodes is larger than an electrode spacing transverse to a flow direction.

4. The field cage according to claim 1, wherein individual cage electrodes are arranged on just one side with respect to the particle to be fixed.

5. The field cage according to claim 1, wherein the cage electrodes are in each case planar.

6. The field cage according to claim 1, wherein the cage electrodes are arranged in a common electrode plane.

7. The field cage according to claim 1, wherein the cage electrodes are arranged in two parallel planes which are offset with respect to one another.

8. The field cage according to claim 1, wherein the cage electrodes are arranged concentrically with respect to one another.

9. The field cage according to claim 1, wherein the cage electrodes are arranged eccentrically with respect to one another.

10. The field cage according to claim 1, wherein the annular cage electrodes are in the shape of any of the group comprising elliptical, circular, polygonal and rectangular shapes.

11. The field cage according to claim 1, wherein at least one of the annular cage electrodes is open at one side.

12. The field cage according to claim 1, wherein the cage electrodes are of different shapes.

13. The field cage according to claim 1, wherein at least one of the cage electrodes is arranged on a substrate.

14. The field cage according to claim 13, wherein the substrate is glass, plastic or silicon.

15. The field cage according to claim 13, wherein the substrate is provided with a member selected from the group consisting of a passivation layer, a biochemical coating and a nanolayer.

16. The field cage according to claim 15, wherein the biochemical coating modifies adhesion properties of the substrate for the particles.

17. The field cage according to claim 15, wherein
a) different coatings are applied to the substrate inside an inner annular cage electrode and outside the inner annular cage electrode,
b) a coating inside the inner annular cage electrode has an adhesive effect on the particles to be fixed, and
c) a coating outside the inner annular cage electrode has a repelling effect on the particles to be fixed.

18. The field cage according to claim 1, wherein the field cage is a dielectrophoretic field cage.

19. The field cage according to claim 18, wherein the field cage is either a positive dielectrophoretic field cage or a negative dielectrophoretic field cage.

20. The field cage according to claim 1, further comprising a counter-electrode, wherein the counter-electrode on the one hand and the annular cage electrodes on the other hand are arranged in parallel electrode planes which are arranged at a distance from one another.

21. A microfluidic system comprising:
a) a carrier flow channel for receiving a carrier flow with particles suspended therein, and
b) an electrically controllable field cage with a plurality of cage electrodes for spatially fixing the particles in the carrier flow,
wherein the field cage is designed according to claim 1.

22. The microfluidic system according to claim 21, wherein an inner annular cage electrode surrounds an opening in a channel wall of the carrier flow channel, it being possible for the suspended particles to enter or exit through the opening.

23. The microfluidic system according to claim 21, wherein the field cage has a certain trapping point at which the particles are spatially fixed, the trapping point being located directly on a channel wall of the carrier flow channel.

24. The microfluidic system according to claim 21, wherein the field cage has a certain trapping point at which the particles are spatially fixed, the trapping point being located at a distance from channel walls of the carrier flow channel.

25. The microfluidic system according to claim 21, wherein a substrate with the cage electrodes is arranged on a channel wall of the carrier flow channel.

26. The microfluidic system according to claim 25, wherein the substrate with the cage electrodes is arranged on an upper channel wall of the carrier flow channel.

27. The microfluidic system according to claim 25, wherein the substrate with the cage electrodes is arranged on a lower channel wall of the carrier flow channel.

28. The microfluidic system according to claim 25, wherein the substrate with the cage electrodes is arranged on a side channel wall of the carrier flow channel.

29. The microfluidic system according to claim 21, wherein a substrate with the cage electrodes is arranged in the carrier flow channel at a distance from the channel walls of the carrier flow channel and extends in a longitudinal direction of the carrier flow channel.

30. The microfluidic system according to claim 21, wherein
a) a plurality of field cages which each have two cage electrodes are provided, each of said field cages allowing a spatial fixing of the suspended particles,
b) the field cages are arranged in matrix form in a plurality of columns and a plurality of rows,
c) for each column of field cages, in each case a common column control line is provided for all field cages of the respective column, the column control line being connected in each case to the first cage electrode at each field cage of the respective column, and
d) for each row of field cages, in each case a common row control line is provided for all field cages of the respective row, the row control line being connected in each case to the second cage electrode at each field cage of the respective row.

31. The microfluidic system according to claim 21, wherein
a) a plurality of field cages which each have three cage electrodes are provided, each of the individual field cages allowing a spatial fixing of the suspended particles,
b) the inner first cage electrodes are jointly kept at ground or at a floating electric potential,
c) the field cages are arranged in matrix form in a plurality of columns and a plurality of rows,
d) for each column of field cages, in each case a common column control line is provided for all field cages of the respective column, the column control line being connected in each case to the second cage electrode at each field cage of the respective column, and
e) for each row of field cages, in each case a common row control line is provided for all field cages of the respective row, the row control line being connected in each case to the third cage electrode at each field cage of the respective row.

32. The microfluidic system according to claim 21, wherein
a) the cage electrodes are arranged on one channel wall of the carrier flow channel, and
b) a flat counter-electrode is arranged on the opposite channel wall of the carrier flow channel.

33. The microfluidic system according to claim 32, wherein the counter-electrode is transparent.

34. The microfluidic system according to claim 21, wherein the cage electrodes are made from one of the following materials:
a) metal,
b) semiconductor,
c) electrically conductive polymers, and
d) laser-modifiable polymers.

35. A micromanipulator, for manipulating particles which are suspended in a carrier fluid, comprising a field cage according to claim 1 for spatially fixing the particles.

36. (canceled)

37. An operating method for a microfluidic system with a carrier flow channel for receiving a carrier flow with particles suspended therein and an electrically controllable field cage for spatially fixing the particles, wherein the field cage is a field cage according to claim 1.

38. The operating method according to claim 37, wherein at least one of the annular cage electrodes has at least one member selected from the group consisting of an opening and a passivation layer at one side, the field cage being controlled by the following steps:
a) electrically actuating the field cage at a first frequency for spatially fixing the suspended particles, the first frequency being high enough to form a trapping field, and
b) subsequently electrically actuating the field cage at a second frequency for releasing the trapped particles, the second frequency being lower than the first frequency and low enough to open the trapping field in the region of the opening or the passivation layer.

39. The operating method according to claim 37, comprising the following step:
irradiating at least one of the cage electrodes by a laser, so that electrode material is removed from the irradiated cage electrode and as a result an opening is produced in the cage electrode.

40. The operating method according to claim 37, wherein the microfluidic system has a plurality of field cages, comprising the following steps:
a) switching off the field cages,
b) flushing in the carrier fluid with the particles suspended therein into the carrier flow channel,
c) electrically actuating the field cages so that individual field cages in each case spatially fix suspended particles,
d) flushing out of the carrier flow channel the particles which are not fixed in the field cages,
e) switching off or reducing the flow in the carrier flow channel in order to consolidate the particles fixed in the field cages, and
f) electrically actuating the field cages so that the cell aggregates forming of the fixed particles are structured.

41. The operating method according to claim 40, comprising the following step:
optically checking whether particles are fixed in the individual field cages.

42. The operating method according to claim 40, comprising the following step:
generating a chemical gradient between the individual field cages by influencing the flow in the carrier flow channel.

43. The operating method according to claim 40, comprising the following step:
analyzing the spatially fixed particle at at least one of the field cages.

44. The operating method according to claim 40, comprising the following step:
electrically actuating at least one of the field cages in order to trigger stimulation of the particles fixed therein.

45. The operating method according to claim 40, comprising the following step:
electrically controlling at least one of the field cages in order to measure at least one electrical parameter on the particle fixed therein.

46. The operating method according to claim 40, comprising the following step:
electrically controlling at least one of the field cages in order to measure at least one electrical parameter on an immediate environment of the particle fixed therein.

47. The field cage according to claim 1, wherein precisely three cage electrodes are provided.

48. The field cage according to claim 1, wherein the cage electrodes are arranged on one surface.

49. The field cage according to claim 1, wherein at least one annular cage electrode has a passivation layer at one side.

50. The field cage according to claim 15, wherein the biochemical coating sets differentiation signals for the fixed particles.

51. The microfluidic system according to claim 32, wherein the counter-electrode is made from one of the following materials:
a) metal,
b) semiconductor,
c) electrically conductive polymers,
d) laser-modifiable polymers.
